(19) United States
(12) Patent Application Publication
(10) Pub. No.: US 2009/0157439 A1
(43) Pub. Date: Jun. 18, 2009

(54) System and method for travel related commercial interactions

(76) Inventor: Meir Fuchs, Nes Ziona (IL)

Correspondence Address: DR. D. GRAESER LTD., 9003 FLORIN WAY, UPPER MARLBORO, MD, 20772, US

(21) Appl. No.: 12/314,552

(22) Filed: Dec. 12, 2008

Related U.S. Application Data
(60) Provisional application No. 60/996,981, filed on Dec. 13, 2007.

(51) Int. Cl. G06Q 10/00

(52) U.S. Cl. 705/6; 705/5

(57) ABSTRACT

A system and a method for travel related commercial interactions through an aggregating system, such as a website for example. The aggregating system may optionally comprise a social network, such as a social networking web site.

This Application claims priority from U.S. Provisional Application No. 60/996,981, filed on Dec. 13, 2007, which is hereby incorporated by reference as if fully set forth herein.

### FIELD OF THE INVENTION

The present invention relates generally to the field of on-line commercial interactions, and more specifically to such commercial interactions which are performed by way of a “push” system providing ordering opportunities for persons who have expressed an interest in traveling in a particular way.

### BACKGROUND OF THE INVENTION

With the rapid increase in the number of people worldwide who have access to network connected computing devices such as computers, interactive TVs and DVDs, cellular phones and personal digital assistants (PDA), there is an ever increasing demand for travel information and for commercial interactions involving travel, especially on the Web.

Currently, if a user wishes to purchase airline tickets, for example, over the Internet, the user must actively search among numerous websites in order to find a travel deal which suits his/her plans. For example, the user may decide to purchase such tickets from the website of a particular airline, although this would limit the user's choices to those provided through the airline. The user may also decide to purchase tickets through a website, such as Orbitz or Expedia, which provide the opportunity to purchase tickets from a number of different airlines, or travel search engines such as Kayak and others. However, again the user is limited to the airlines or wholesalers which operate through these websites. Such websites do not always offer many or all the options for international travel, nor do they offer all options from regional carriers (whether in the US or internationally). Also, the websites only permit the user to “pull” information, upon making a specific request.

In addition there are a multitude of on-line services which upon request send notices to subscribers offering them various travel and hotel deals which are being offered by certain airlines or hotel chains, etc. More often than not these deals are not such as to be of interest to most subscribers, who usually have specific travel needs and are not prone to ordering a deal to a destination offered just because there is a “sale” on such deal. In addition, airlines are extremely concerned with airplanes that take off with unsold seats, as each seat not sold cannot be sold in the future and constitutes an immediate loss for the airline. This concern is even more valid for charter flight operators which are likely to suffer losses for each seat not filled, given their tighter margins. In addition “last minute” travel opportunities which are available with airlines, or other travel purveyors, do not reach the likely user in an effective manner in order for such user to take up such opportunity in a timely manner.

### SUMMARY OF THE INVENTION

Thus there is a need for, and it would be advantageous to have a system and method that does not require the user to “pull” travel information, but which instead allows a user to register his/her travel needs in advance and to have a travel purveyor “push” the information to a specific user, such that a match could be created between a specific travel need and the ability of a travel purveyor to fill such need. There is also a need for, and it would be advantageous to have such a system and method which operates through a website or alternatively through a social networking website, such that user profile information could be easily obtained.

The present invention overcomes these deficiencies of the background art by providing (in some embodiments) a system and method for providing travel related commercial interactions through any kind of information or data aggregating system (an “aggregating system”) which may optionally comprise an aggregating website. As a non-limiting illustrative example of such a system, the travel related commercial interactions could optionally be provided through a social networking system, which may for example optionally comprise a social networking website. The aggregating system could optionally comprise another collection of users who provide information about the type of travel in which they are interested in such a manner that the aggregate information is useful for commercial interactions.

The travel related commercial interaction is preferably performed with a travel purveyor. In some embodiments, the commercial interaction involves the purchase of airline tickets from a purveyor of such tickets. The user preferably provides information about one or more travel preferences, after which the ticket purveyor preferably sends the user a description of one or more travel possibilities. More preferably the ticket purveyor comprises an airline. A travel purveyor as described herein may optionally include an airline, a travel agency, a cruise line, a train or bus line or system; rental car agency; a touring agency; a private tour guide; a hotel, resort or other accommodation, including also chains or associations of such accommodations; a loyalty or “frequent flyer” program for any of the above; and so forth.

The travel preferences of the user may optionally be provided through a profile, for example. The profile may optionally be related to and/or a part of the user profile for the aggregating system, such as a social networking system for example. Alternatively or additionally, the profile may optionally be separate, such that the user for example may optionally provide the information for the profile separately from that for the aggregating system.

Social networking systems encompass certain on-line services that provide a group of individuals with the ability to collaborate with each other over the internet. Examples of social networking systems may be found at “myspace.com”, “friendster.com”, “Facebook” (facebook.com) and “tribe.net”. Social networking systems generally consist of an on-line social network, which is represented by a map of the relationships between individuals. The social network, or map of relationships, indicates the ways in which such individuals are connected through various social familiarities ranging from casual acquaintance to close familial bonds.

The above aspects of social networking systems also enable them to be useful for assisting in commercial interactions involving travel. Users may be expected to at least partially rely upon the opinion of others in their social network with regard to travel purchases. Furthermore, the provision of user information through social networking systems also enables offers for such travel commercial interactions to be provided to the user from the purveyor, such as from the airline, in a form of targeted push. Currently, airlines can only send blanket offers to multiple users in a form of broadcast without knowing whether there is any real interest or need for such offers. As these offers are not tailored to the individual user, they may not be of interest and in fact may cause annoyance. The alternative, “pulling” information by the user, for example through a search, may also cause frustration if the user cannot frame the request within the limited choices provided by travel related websites, or if the travel related website is unable to offer the user a precise match with the requested travel preferences.

The present invention overcomes these problems by providing a truly targeted push service, in which a purveyor of tickets, such as an airline for example, uses information from a user profile, whether a particular user profile for travel and/or the general user profile for the aggregating system, for example a profile sent to an aggregating website, to provide such targeted information. The large aggregation of individuals through a particular aggregating website or system enables such targeted push to be commercial viable.

With regard to the non-limiting example of social networking systems, the interactions of individuals on the social networking system may further permit additional targeted push; for example, users may optionally be able to recommend particular travel deals or travel packages to their peers, friends or family members on a social networking system (an “originating member”).

Optionally and more preferably, peers, friends or family members with whom a user is connected may be able to view one or more details of upcoming, present or past travel plans of the user. For example, as a user is planning a trip, connected members of the social networking system may optionally be able to view one or more details, including but not limited to the general geographic destination, a specific location, a hotel or other accommodation, an airline and/or train and/or other travel mode (preferably by brand name) and/or any other detail of the trip that the user wishes to share. Preferably, the user is able to share different details and/or levels of information with different members of the social networking system. During and/or after the trip, the user is preferably able to share any desired detail(s) of the travel experience, including but not limited to opinions of one or more aspects of the trip, photographs, any interesting scanned images, audio recordings and so forth. Also during and/or after the trip, the user may optionally choose to share one or more additional details with one or more social networking members than had been provided before the trip was initiated.

Optionally and preferably, a member viewing such one or more details may be able to indicate a desire to replicate one or more aspects of the trip. For example, on a website, optionally the member would be able to select a GUI (graphical user interface) gadget such as a button for example, which would quickly and easily allow the member to reproduce one or more aspects of the trip expressing a desire to obtain the same travel offers as those placed by the originating member. Optionally, the member is able to share the experience of his or her trip, for example preferably after completion and/or during the trip itself, with reviews of hotels, sights, attractions restaurants and so forth, optionally and preferably with both images and text. The images may also optionally comprise video and/or audio data.

According to some embodiments, the identity of the airline and/or other travel purveyor providing a particular travel commercial offer may optionally be kept secret until the user has accepted the deal. According to some embodiments, the airline and/or other travel purveyor would provide an ordering code, such that only with the mention of same would the user be allowed to order the travel deal as offered on the website or as the travel deal offered to such individual user. Acceptance may optionally comprise payment by the user to the travel purveyor, whether partial or complete payment.

According to other embodiments of the present invention, payment is made by the user to an intermediary, such that payment to the travel purveyor is made indirectly from the user. One or more intermediaries may optionally handle such payment from the user to the travel purveyor.

According to other embodiments of the present invention, one or more travel purveyor software components may optionally be implemented at the aggregating system in order to allow the travel purveyor to interact more directly with the users of the aggregating system and to offer a direct match to the travel profile which was placed on the website by a user. For example, such components could optionally allow users to interact directly with a website of the travel purveyor; alternatively or additionally, such components could optionally allow users to interact with the travel purveyor at the aggregating website, such as for example a social networking website.

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or stages manually, automatically, or a combination thereof. Moreover, according to actual instrumentation and equipment of preferred embodiments of the method and system of the present invention, several selected stages could be implemented by hardware or by software on any operating system of any firmware or a combination thereof. For example, as hardware, selected stages of the invention could be implemented as a chip or a circuit. As software, selected stages of the invention could be implemented as a plurality of software instructions being executed by a computer using any suitable operating system. In any case, selected stages of the method and system of the invention could be described as being performed by a data processor, such as a computing platform for executing a plurality of instructions.

Although the present invention is described with regard to a “computer” on a “computer network”, it should be noted that optionally any device featuring a data processor and/or the ability to execute one or more instructions may be described as a computer, including but not limited to a PC (personal computer), a server, a minicomputer, a cellular telephone, a smart phone, a PDA (personal data assistant), a pager. Any two or more of such devices in communication with each other, and/or any computer in communication with any other computer, may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 shows a schematic block diagram of an exemplary, illustrative system for social networking with travel commercial interactions according to the present invention;

FIG. 2 shows a schematic block diagram of an exemplary, illustrative system for social networking with travel commercial interactions according to the present invention by a travel purveyor;

FIG. 3 shows a flowchart of an exemplary method according to the present invention for a travel commercial interaction within an aggregating system; and

FIG. 4 shows a flowchart of an exemplary method according to the present invention for a travel commercial interaction for reproducing one or more aspects of a trip.

### DESCRIPTION OF THE PREFERRED EMBODIMENTS

The present invention is of a system and method for providing travel related commercial interactions through an aggregating system which may optionally comprise an aggregating website. As a non-limiting illustrative example of such a system, the travel related commercial interactions could optionally be provided through a social networking system, which may for example optionally comprise a social networking website. The travel related commercial interaction is preferably performed with a travel purveyor. In some embodiments, the commercial interaction involves the purchase of airline tickets from a purveyor of such tickets. The user preferably provides information about one or more travel preferences, after which the ticket purveyor preferably sends the user a description of one or more travel possibilities. More preferably the ticket purveyor comprises an airline.

Without wishing to be limited in any way, the present invention overcomes many problems of the background art, particularly those problems that are associated with proprietary travel coordination solutions, such as ATRIIS (an on-line travel management product of ABT—Amsalem Business Travel) or the various computer reservations of different airlines, not all of which are universally accessible through a single computer interface. Furthermore, such proprietary solutions frequently do not include one or more travel networks and/or airlines and/or hotels (or hotel chains), thereby restricting the choice of the traveler when using such proprietary solutions. In addition, access through various types of GDS (global distribution systems) may also be restricted, such that for example it is currently not possible to access all airlines through a single GDS; indeed some airlines do not belong to any such GDS. The present invention overcomes these problems of the background art, in at least some embodiments, by providing a solution that is not limited to a particularly proprietary system or computer interface, but which instead is able to operate with any such system or interface.

The principles and operation of the present invention may be better understood with reference to the drawings and the accompanying description.

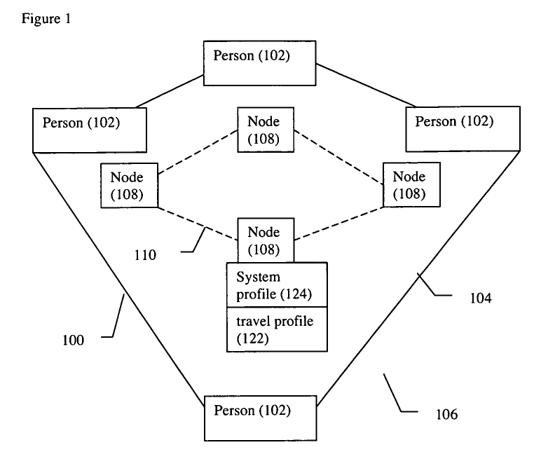

Referring now to the drawings, FIG. 1 shows human social network 100. The human social network 100 is a network of persons 102 linked by some social relationships 104. The persons 102 and relationships 104 can be of any type. For example, the persons 102 may be employees of a company and the relationships 104 might be “know” relationships (who knows who), who has communicated with who, etc. The human social network 100 can be represented by information stored on a computer, preferably as a graph. In FIG. 1, social network 106 represents the human social network 100. The social network 106 has nodes 108 that correspond to respective persons 102, and connectors 110 that correspond to the relationships 104.

As described herein, preferably the human social network 100 relates to a computer network, wherein communication between nodes 108 occurs through computers operated by respective persons 102. Optionally, each such node 108 represents an on-line presence of a person 102, for example through a computer of any time, whether a personal computer, hand held device, a smart telephone or any type of cellular telephone, pager or other wireless communication device. Therefore, social network 106 is preferably implemented as a computer network.

The information that makes up the social network 106 can be obtained in many ways and from many types of sources. For example, a person can manually add a node representing his or her self and a set of people to which the person is related. Information about how they are related can also be added. Detail about the person can be included with the node. Information for the social network 106 can also be collected automatically from communication information such as sent email messages (sender and receiver fields can be used to build connections), documents such as news articles (semantic analysis of documents can reveal relationships between people), web pages or structured documents (people and their relations may be indicated by tags), a database storing records about people and perhaps transactions between them, and so on. A social network can also be built up from other social networks.

FIG. 1 shows that social network 106 preferably also comprises a travel profile 122 for at least one person 102, which preferably represents on-line information that is stored and accessed through a computer network. Travel profile 122 is preferably associated with a social network system profile 124 for the user 102 at node 108, but may optionally also form a part of the social network system profile 124 itself. It is understood that social network 106 is operated through a computer system, with a plurality of computers, for example optionally such that each node 108 comprises a user computer (or at least a computer accessible by the user 102). For the purpose of description only and without any intention of being limited, it should be noted that such a user computer could optionally comprise a wireless device, such as a cellular telephone for example.

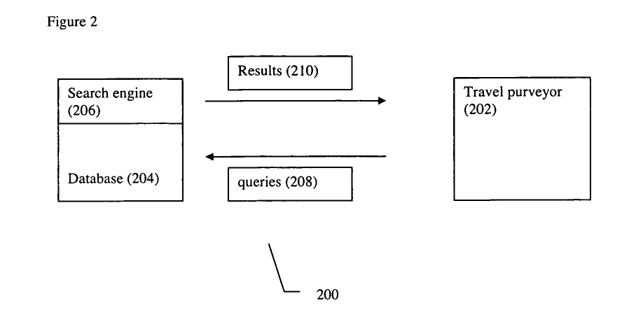

FIG. 2 shows a system 200 for analyzing the social network 106 by a travel purveyor 202 (social network 106 not shown in this Figure). Again, it is understood that system 200 is preferably implemented as a computer network, while travel purveyor 202 preferably communicates with system 200 through some type of computer interface, such as a server for example (not shown). A database 204 stores the nodes and connections of the social network 106. A search engine 206 receives queries 208 from travel purveyor 202 that are directed to the social network 106, searches the database 204 for the information that satisfies the queries 208, and returns results 210. Optionally, a special software interface may optionally be provided which permits one or more aspects of the software and/or other operating system of travel purveyor 202 to be directly linked to search engine 206 and/or to one or more other aspects of system 200 (not shown). The system 200 can reside on one server computer (not shown), or it can be distributed across a network of servers that cooperate to handle search requests.

Once a result 210 has been obtained, travel purveyor 202 preferably sends the user (not shown) an offer for travel, preferably to the user computer (such as node 108 of FIG. 1 for example). For example, travel purveyor 202 may optionally choose to send an offer to purchase airline tickets to a certain travel location at a particular date and/or range or plurality of dates, based upon information previously obtained about the user and stored in database 204. The offer may optionally be sent according to any messaging mechanism, including but not limited to e-mail, instant messaging, SMS (short message service) messages, MMS (multimedia messaging service) messages and so forth; of course, voice communication is also possible, as is regular mail or other paper document delivery.

Although FIGS. 1 and 2 relate to an illustrative, optional exemplary embodiment of the present invention as provided through a social network system, such as a social networking website for example, in fact any aggregating system may optionally be used. However, preferably the aggregating system comprises or is implemented as a computer system.

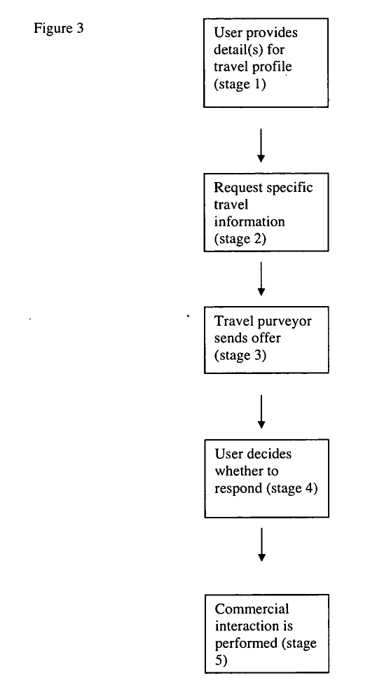

FIG. 3 relates to a flowchart for an exemplary, illustrative method according to some embodiments of the present invention for any aggregating system. As shown, in stage 1, a user provides one or more details for a travel profile in an aggregating system, which may for example optionally and preferably comprise an aggregating website. Optionally as described above, the aggregating system may comprise a social networking system, such as for example a social networking website. As described herein, the aggregating system is preferably based upon or supported by a computer network, such that the operations below are preferably performed through interactions between human users and the computers of the computer network.

The travel profile may optionally be combined with, but may alternatively be separate to, a user profile for the user in the aggregating system. The details for the travel profile preferably include but are not limited to planned vacation dates (with optional flexibility); travel budget; preferred locations for travel, whether specific (Dubuque, Iowa) or general (the Caribbean, anyplace abroad, a location with good weather); preferred length of trip; whether children are to be included; whether pets are to be included; whether any type of special accommodation needs to be made for the traveler (for example for a handicap); and so forth.

In stage 2, the user may optionally request information regarding specific travel on a specific set of dates.

In stage 3, the travel purveyor preferably analyzes such travel information in order to send an offer to at least one user. The analysis may optionally and preferably relate to specific requested travel on specific dates, or may alternatively optionally relate to a more general desire to travel (preferably within at least a particular time frame). Optionally this offer is made with the name of the travel purveyor kept secret.

In stage 4, the user decides whether to respond to the offer.

In stage 5, if the user responds, then preferably a commercial interaction is performed. At this stage optionally payment is required of the user. Also optionally the identity of the travel purveyor is provided to the user.

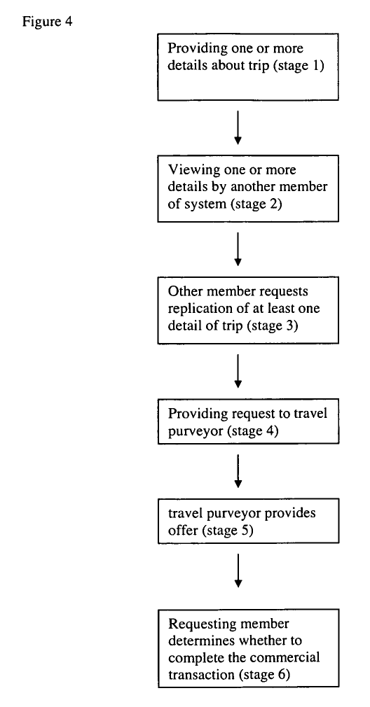

FIG. 4 shows a flowchart of an exemplary method according to the present invention for a travel commercial interaction for reproducing one or more aspects of a trip. As shown in stage 1, a member of an aggregating system, preferably a social networking system, provides one or more details about a trip, whether future, current or past, preferably through a computer interface (such as a through a web page for example). The member optionally also indicates which other members of the aggregating system may view such details; preferably different levels of detail provision are provided according to one or more criteria set by the originating member.

In stage 2, another member of the aggregating system views the one or more details. In stage 3, the other member indicates a desire to replicate one or more aspects of the trip. In stage 4, such a request is preferably provided to the travel purveyor which originally provided such one or more aspects of the trip to the originating member. Alternatively a different travel purveyor may receive such a request. However, stages 3 and 4 may optionally and alternatively be provided as a “push” mechanism, in which the other member alters one or more aspects of a profile, such as a travel profile, and/or otherwise indicates an interest without direct communication to the travel purveyor, after which the travel purveyor preferably “pushes” the offer to the other member. In stage 5, the travel purveyor responds with an offer to the requesting member. In stage 6, the requesting member may optionally choose whether to complete the commercial transaction with the travel purveyor. As previously noted, optionally the commercial transaction features payment directly to the travel purveyor, or alternatively (or additionally) optionally features payment by the requesting member to an intermediary, and then to the travel purveyor. The intermediary may optionally comprise a bank or other financial institution, any type of credit card clearing service, or any type of financial payment service. Optionally, funds may be held in escrow if the requesting member pays in advance of receiving the travel service.

While the invention has been described with respect to a limited number of embodiments, it will be appreciated that many variations, modifications and other applications of the invention may be made.

What is claimed is:

1. A method for a travel commercial interaction through an aggregating system for a user, comprising:
Providing travel related information by the user to the aggregating system;
Analyzing said travel related information; and
Sending a travel related offer for commercial interaction to the user according to said analysis;
Wherein the aggregating system comprises a computer network and wherein at least said analyzing is performed through said computer network.

2. The method of claim 1, wherein said travel related offer is provided by a travel purveyor.

3. The method of claim 1, wherein said travel related information is part of a user profile for the aggregating system.

4. The method of claim 1, wherein said travel related information is part of a separate travel profile for user input into the aggregating system which is different from the user profile.

5. The method of claim 4, wherein said aggregating system comprises a social networking system.

6. The method of claim 5, wherein said social networking system comprises a social networking website.

7. The method of claim 1, wherein said providing, said analyzing and said sending are all performed through said computer network.

8. The method of claim 7, wherein said travel related information further comprises other user travel information, wherein said other user travel information is provided by a different user.

9. The method of claim 8, wherein said user alters said other user travel information in at least one aspect.

10. The method of claim 9, wherein said other user travel information comprises a trip agenda constructed by said different user.

11. The method of claim 7, wherein the user communicates with said social networking website through a wireless communication device.

12. A software interface for a travel purveyor, for interacting with the aggregating system for performing the method of claim 1, the software interface being operated by a computer and also being in communication with said computer network for said operation.

13. A system for performing a travel commercial interaction through an aggregating system for a user, the system comprising:
A user computer for being operated by the user; and
An aggregating system for receiving travel related information from the user through said user computer and for analyzing said travel related information to prepare a travel related offer for commercial interaction to said user computer;
Wherein said aggregating system and said user computer communicate through a computer network.

14. The system of claim 13, wherein said user computer comprises a wireless communication device.

15. The system of claim 13, wherein said aggregating system comprises a travel purveyor server for analyzing said travel related information.

16. The system of claim 15, wherein said aggregating system further comprises a social network system.
